(19) United States
(12) Patent Application Publication
(10) Pub. No.: US 2024/0054573 A1
(43) Pub. Date: Feb. 15, 2024

(54) SYSTEM AND METHOD OF ONLINE DATING SERVICE FOR PET LOVERS

(71) Applicants: Terry JAMES, Redondo Beach, CA (US); Manish METHAI, Bellevue, WA (US)

(72) Inventor: Manish Methai, Bellevue, WA (US)

(73) Assignees: Manish Methai, Bellevue, WA (US); Terry James, Redondo Beach, CA (US)

(21) Appl. No.: 18/271,133

(22) PCT Filed: Jan. 7, 2022
(86) PCT No.: PCT/US22/11645

§ 371 Date: Jul. 6, 2023

Related U.S. Application Data
(60) Provisional application No. 63/134,609, filed on Jan. 7, 2021.

(51) Int. Cl. G06Q 50/00; G06F 16/9535

(52) U.S. Cl. CPC G06Q 50/01; G06F 16/9535

(57) ABSTRACT

A system and method for dating service for pet owners are disclosed. The system comprises a user device, a computing device or matching server, and a plurality of databases. The user device is in communication with the computing device via a network. The plurality of databases are in communication with the computing device via the network configured to store various user information, pet information, event information, and geographic information. The computing device is in communication with the user device and the plurality of databases via the network configured to process the information received from the suitable databases and provide a response back to the user device, thereby connecting the user profile with the plurality of other user profiles or pet owner profiles to view, connect or collaborate or arrange pet events or pet owners meet-ups. Further, the system determines an appropriate user by matching similar user profiles and pet attributes.

### CROSS-REFERENCE TO RELATED APPLICATIONS

This application claims priority to PCT Patent Application No. PCT/US2022/011645, titled “SYSTEM AND METHOD FOR ONLINE DATING FOR PET LOVERS” filed on Jan. 7, 2022 which further claims the priority to U.S. Provisional Patent Application No. 63/134,609, titled “SYSTEM AND METHOD FOR ONLINE DATING FOR PET LOVERS” filed on Jan. 7, 2021. The specification of the above referenced patent applications is incorporated herein by reference in its entirety.

### BACKGROUND OF THE INVENTION

### A. Technical Field

The present invention generally relates to online dating services. More specifically, the present invention relates to a computer-implemented system and method to provide an interactive communication tool specifically for pet lovers allowing them to schedule or arrange pet events or owner's meet-ups.

### B. Description of Related Art

With the advent of technology and the predominant use of smartphones, the way people approach life has widely been dependent on the Internet era. People now get to know each other through cyberspace. These days there is a drastic increase in online dating apps. As pets (such as dogs, cats, etc.) are increasingly viewed as family members, a person's pets may wield significant influence in partner choice. Many pet owners become deeply attached to their pets and they judge and influence their partners based on whether they have pets.

There are various patents relating to social networking and online dating services. Few existing patent references attempted to address the problems cited in the background as prior art over the presently disclosed subject matter and are explained as follows:

A prior art US20200352139 assigned to Samantha Maung entitled “Process for matching pet owners in need of exchange pet sitting and/or setting up playdates” discloses a process for matching pet owners to facilitate pet sitting and socializing of dogs including arranging play dates and dog sitting services. It depicts a web-based pet exchange application directed to matching one pet owner with on-demand pet-related services.

Another prior art U.S. Pat. No. 8,645,479 assigned to Yunfeng LiuHaisong Yang, et. al., entitled “Chatting system, method and apparatus for virtual pet” discloses a chatting system, method, and apparatus for a virtual pet. It employs certain intelligence to interact with pet masters and communicates with them in natural languages. The virtual pet server forwards the natural language sentence to a questioning and answering server and further responds to the pet client.

Another prior art U.S. Ser. No. 10/203,854 assigned to Sean RadTodd M. Carrico, et. al., entitled “Matching process system and method” discloses a process, system and method for user profile matching with another user and dynamically updates match search results based on user activity. The method for profile matching includes receiving a plurality of user profiles, each user profile comprising traits of a respective user. The method includes receiving a preference indication for a first user profile of the plurality of user profiles. The method also includes determining a potential match user profile of the plurality of user profiles based on the preference indication for the first user profile. The method also includes presenting the potential match user profile to a second user.

Another prior art U.S. Pat. No. 9,830,669 assigned to Markus Frind entitled “System and method for adaptive matching of user profiles based on viewing and contact activity for social relationship services” discloses a system and method for adaptive matching of user profiles for social relationships and online dating services. It generates the adaptive recommendations using previously generated user activity that indicates user preferences of particular attributes.

Another prior art US20190065609 assigned to Jason Stuart Finder entitled “Online social networking service with human matchmaking” discloses systems, methods, and computer-readable media for an online social networking service with human matchmaking.

Though there are many online dating apps in the market, they haven't brought the concept of dating through the aspect of pets. Therefore, there is a need for a computer-implemented system and method for online dating services, especially for pet lovers. Moreover, there is a need for an application or tool using artificial intelligence and matching algorithms to accomplish dating services. Also, there is a need for an interactive communication tool that allows users to schedule or arrange pet events or owner's meet-ups. Further, there is a need for a system and method for determining an appropriate user by matching similar user profiles and pet attributes.

### SUMMARY OF THE INVENTION

The present invention generally discloses an online dating application. Also, the present invention discloses a computer-implemented system and method for providing online dating service, especially for pet lovers. Further, the present invention discloses a system and method that provides an interactive communication tool specifically for pet lovers allowing them to schedule or arrange pet events or owner's meet-ups.

According to the present invention, the system provides an online dating service, specifically for pet lovers or pet owners. In one embodiment, the system provides a simplified communication network for facilitating online dating services. In one embodiment, the system allows users to schedule or arrange meetings based on matched user profiles. In one embodiment, the user profiles are matched or determined based on details of user and pet attributes.

In one embodiment, the system is an application software or mobile application or, web-based application. In one embodiment, the application is executed in a computer-implemented environment or network environment. In one embodiment, the computer-implemented environment comprises a plurality of user devices and a computing device or online dating server or matching server. Each user device is associated with a user or pet owner or client. The user device is enabled to access the matching server via a communication network. The user device has a user interface. In one embodiment, the user device is at least any one of a smartphone, a mobile phone, a laptop, a computer, a desktop, a tablet, or other suitable mobile and/or handheld electronic communication devices. In one embodiment, the user device comprises a storage medium in communication with the network to access the matching server configured to send and receive a plurality of user information and pet information. In an embodiment, the network may be a Wi-Fi network, a WiMAX network, a local area network (LAN), a wide area network (WAN), and a wireless local area network (WLAN).

In one embodiment, the matching server comprises a processor and a memory unit. The memory unit is in communication with the processor. The memory stores a set of instructions executed by the processor. In one embodiment, the matching server may be a server or cloud server. The server is configured to collect one or more parameters from the user device. In one embodiment, the server may be operated as a single computer. In some embodiments, the computer could be a touchscreen and/or non-touchscreen. In one embodiment, the plurality of computers is in communication with each other, via the network. Such communication is established via a software application, a mobile app, a browser, an OS, and/or any combination thereof.

In one embodiment, the computer-implemented network environment further comprises a plurality of databases. In one embodiment, the plurality of databases include, but are not limited to, a user database, a pet database, an event database, and a geographic database. In one embodiment, the databases are in communication with the matching server via the network configured to store a plurality of user information, pet information, events information, and geographic information. In one embodiment, each database is accessible by the matching server.

In one embodiment, the matching server communicates with the client interface via the network configured to connect a user profile with a plurality of other user profiles or pet owner profiles to view, connect or collaborate or arrange pet events or pet owners meet-ups. In one embodiment, the matching server further stores and retrieves data from the suitable databases such as user database, pet database, events databases, and geographic databases via the network and processes it. In one embodiment, the matching server responds back to the user device via the network. In one embodiment, the user device provides a two-way connection to the distributed network and further has a two-way communication to the matching server via the network. In one embodiment, the matching server is configured to enable the user to view other pet owner's profile to determine the match using the pre-installed application or application software.

In one embodiment, the computer-implemented network environment includes a plurality of user profiles. In one embodiment, the user profile is generated by registering user information or one or more user credentials into the user device via the user interface. In one embodiment, the user profile is determined based on user preference. In one embodiment, the user profile is determined by matching a plurality of pet owner's profiles based on pet profiles, pet attributes, pet birthday, pet's personality traits, pet name, pet age, pet type, and breeds stored in the database. In one embodiment, the user profile is determined by matching a plurality of pet owner's profiles with provision for viewing, sharing, and connecting with matched user profiles based on weighting factors and scores stored in the database. In one embodiment, the user profile is determined by matching a plurality of pet owner's profiles with provision for retrieving matched pet owner detail based on geographical location stored in the database. In one embodiment, the matching server is configured to check the matching user profiles for the current user/client; display or share the matching pet owners profile to the current user/client, and link or connect the current user/client by sharing the matching user's details to set pets/owners events and meet-ups.

In one embodiment, a method for facilitating online dating service is disclosed. The method comprises the following steps. At one step, a user registers into the system with a client interface i.e., Offleash'd interface to facilitate an online dating service between multiple pet lovers/clients. In one embodiment, the user profile is generated by registering one or more user information and pet information into the system via the user interface. At another step, the registered user/client profiles get stored in appropriate databases. In one embodiment, the user details and attributes are registered in a user database. In one embodiment, the attributes related to pets such as pet breeds, pet types, pet birthday, pet's personality traits, pet name, pet age, etc. are registered in a pet database. In one embodiment, the details relating to meet-ups, event details such as meet-ups for pet owners or pets, pet businesses etc. get registered in a events database. In one embodiment, the details relating to the location of the pet user are stored in a geographic database which enables the users to filter their matching profiles within or nearer their geographic location.

Further, the application allows the user to communicate with any of the other user. The user may create a group or join a group having a plurality of pet lovers. The system uses a predictive artificial intelligent (AI) technology. The predictive AI technology categorizes the user information and pet information to create different layers, which helps to find the match for friends, relationships, event to attend, and pet products to purchase and the type of animal to adopt during the date.

At another step, the system executes the matching server comprising a matching algorithm using the retrieved data from the appropriate databases. In one embodiment, the algorithm checks for matching user profiles for the current user/client and generates matching profiles to the current user/client. In one embodiment, the user profile is determined based on the user preference. If a match/similar profile is not determined, the system moves to the previous step and checks for other matching profiles among multiple user profiles. If a match/similar profile is determined, the system the next step. At another step, the system generates or sets pets or owners events, meet-ups, etc. At another step, the system displays or shares the matching pet owner's profile to the current user/client. At another step, the system includes an option to share the matching user details to the current user/client. At another step, the system includes an option to link to connect the current user/client to the appropriate user.

In one embodiment, the system allows the current user/client to select the matching profile based on the user preference. In one embodiment, the system provides dynamic recommendations of matching user profiles based on the user profiles, owner's interests, location, and the like. In one embodiment, the system allows the appropriate pet owners and their pets to dynamically update and/or arrange events such as meet-ups, pet businesses, clinical sessions, and pet-friendly dine with the other pet-owners and their pets.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and structures disclosed herein. The description of a method step or a structure referenced by a numeral in a drawing is applicable to the description of that method step or structure shown by that same numeral in any subsequent drawing herein.

FIG. 1 shows a schematic view of an illustrative system executed in a computer-implemented environment for a networking service in an embodiment of the present invention.

FIG. 2 shows a plurality of relevant databases in communication with each other for providing online dating service between the pet owners in one embodiment of the present invention.

FIG. 3 shows a flowchart illustrating a method of online dating service in one embodiment of the present invention.

FIG. 4 shows a screenshot illustrating a home page for pet owners in one embodiment of the present invention.

FIG. 5 shows a screenshot illustrating the creation of a user profile for pet owners in one embodiment of the present invention.

FIG. 6 shows a screenshot having one or more details of the pet in one embodiment of the present invention.

FIGS. 7-8 show screenshots having one or more details of the pet owner or user in one embodiment of the present invention.

FIG. 9 shows a screenshot to edit one or more user credentials provided in the user profile in one embodiment of the present invention.

### DETAILED DESCRIPTION OF EMBODIMENTS

A description of embodiments of the present invention will now be given with reference to the Figures. It is expected that the present invention may be embodied in other specific forms without departing from its spirit or essential characteristics. The described embodiments are to be considered in all respects only as illustrative and not restrictive.

Unless otherwise defined, all terms (including technical and scientific terms) used herein have the same meaning as commonly understood by one of ordinary skill in the art of this disclosure. It will be further understood that terms, such as those defined in commonly used dictionaries, should be interpreted as having a meaning that is consistent with their meaning in the context of the specification and should not be interpreted in an idealized or overly formal sense unless expressly so defined herein. Well known functions or constructions may not be described in detail for brevity or clarity.

The terminology used herein is for the purpose of describing particular embodiments only and is not intended to be limiting. As used herein, the singular forms “a”, “an” and “the” are intended to include the plural forms as well, unless the context clearly indicates otherwise.

With reference to the use of the words “comprise” or “comprises” or “comprising” in the foregoing description and/or in the following claims, unless the context requires otherwise, those words are used on the basis and clear understanding that they are to be interpreted inclusively, rather than exclusively, and that each of those words is to be so interpreted in construing the foregoing description and the following claims.

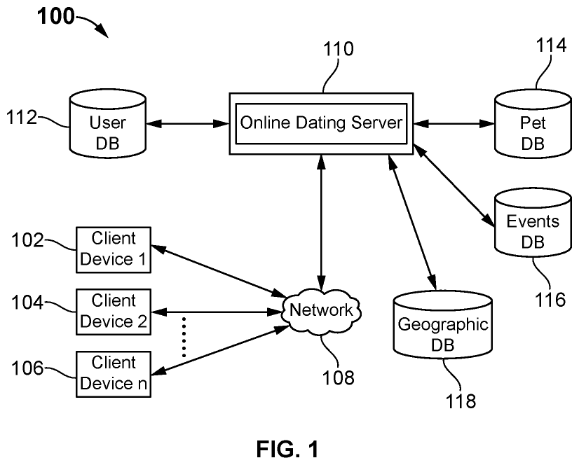

Referring to FIG. 1, a schematic view of an illustrative system or online dating service system (hereinafter referred as system) executed in a computer-implemented network environment 100 configured to provide a networking service, according to one embodiment of the present invention. In one embodiment, the system is designed to provide an online dating service, specifically for pet lovers or pet owners. In one embodiment, the system provides a simplified communication network for facilitating online dating services. In one embodiment, the system provides an interactive communication tool for pet lovers or owners allowing them to schedule or arrange pet events or owner's meet-ups. In one embodiment, the system determines a user based on matching similar user profiles and pet attributes present in the system.

In one embodiment, the system is an application software or mobile application or, web-based application. In one embodiment, the application is executed in the computer-implemented environment or network environment 100. In one embodiment, the computer-implemented environment 100 comprises a plurality of user devices (102, 104, and 106) and a computing device or online dating server or matching server 110. Each user device (102, 104, and 106) is associated with a user or pet owner or client. The user device (102, 104, and 106) is enabled to access the matching server 110 via a communication network 108. The user device (102, 104, and 106) has a user interface. In one embodiment, the user device 102 is at least any one of a smartphone, a mobile phone, a laptop, a computer, a desktop, a tablet, or other suitable mobile and/or handheld electronic communication devices. In one embodiment, the user device (102, 104, and 106) comprises a storage medium in communication with the network 108 to access the matching server 110 configured to send and receive a plurality of user information and pet information. In an embodiment, the network 108 may be a Wi-Fi network, a WiMAX network, a local area network (LAN), a wide area network (WAN), and a wireless local area network (WLAN).

In one embodiment, the matching server 110 comprises a processor and a memory unit. The memory unit is in communication with the processor. The memory stores a set of instructions executed by the processor. The memory unit may be RAM, ROM (including EPROM, EEPROM, PROM). In one embodiment, the matching server 110 may be a server or cloud server. The server is configured to collect one or more parameters from the user device (102, 104, and 106). In one embodiment, the server may be operated as a single computer. In some embodiments, the computer could be a touchscreen and/or non-touchscreen and adopted to run on any type of OS, such as iOS™, Windows™, Android™ Unix™, Linux™, and/or others. In one embodiment, the plurality of computers is in communication with each other, via the network 108. Such communication is established via a software application, a mobile app, a browser, an OS, and/or any combination thereof.

In one embodiment, the computer-implemented network environment 100 further comprises a plurality of databases. In one embodiment, the plurality of databases includes, but are not limited to, a user database 112, a pet database 114, an event database 116, and a geographic database 118. In one embodiment, the databases (112, 114, 116, and 118) are in communication with the matching server 110 via the network 108 configured to store a plurality of user information, pet information, events information, and geographic information. In one embodiment, each database (112, 114, 116, and 118) is accessible by the matching server 110. In another embodiment, each database (112, 114, 116, and 118) is integrated into the matching server 110 or separate from it. In some embodiments, the databases (112, 114, 116, and 118) reside in a connected server or a cloud computing service. Regardless of location, the databases (112, 114, 116, and 118) comprise a memory to store and organize certain data for use by the matching server 110.

In one embodiment, the matching server 110 communicates with the client interface (102, 104 and 106) via the network 108 configured to connect a user profile with a plurality of other user profiles or pet owner profiles to view, connect or collaborate or arrange pet events or pet owners meet-ups. In one embodiment, the matching server 110 further stores and retrieves data from the suitable databases such as user database 112, pet database 114, events databases 116 and geographic databases 118 via the network 108 and processes it. In one embodiment, the matching server 110 responds back to the user device (102, 104 and 106) via the network 108. In one embodiment, the user device (102, 104 and 106) provides a two-way connection to the distributed network 108 and further has a two-way communication to the matching server 110 via the network 108. In one embodiment, the matching server 110 is configured to enable the user to view other pet owner's profile to determine the match using the pre-installed application or application software.

In one embodiment, the computer-implemented network environment 100 includes a plurality of user profiles. In one embodiment, the user profile is generated by registering user information or one or more user credentials into the user device (102, 104, and 106) via the user interface. In one embodiment, the user profile is determined based on user preference. In one embodiment, the user profile is determined by matching a plurality of pet owner's profiles based on pet profiles, pet attributes, and breeds stored in the database. In one embodiment, the user profile is determined by matching a plurality of pet owner's profiles with provision for viewing, sharing, and connecting with matched user profiles based on weighting factors and scores stored in the database. In one embodiment, the user profile is determined by matching the plurality of pet owner's profiles with provision for retrieving matched pet owner detail based on geographical location stored in the database (112, 114, 116, and 118). In one embodiment, the matching server 110 is configured to check the matching user profiles for the current user/client; display or share the matching pet owners profile to the current user/client, and link or connect the current user/client by sharing the matching user's details to set pets/owners events and meet-ups.

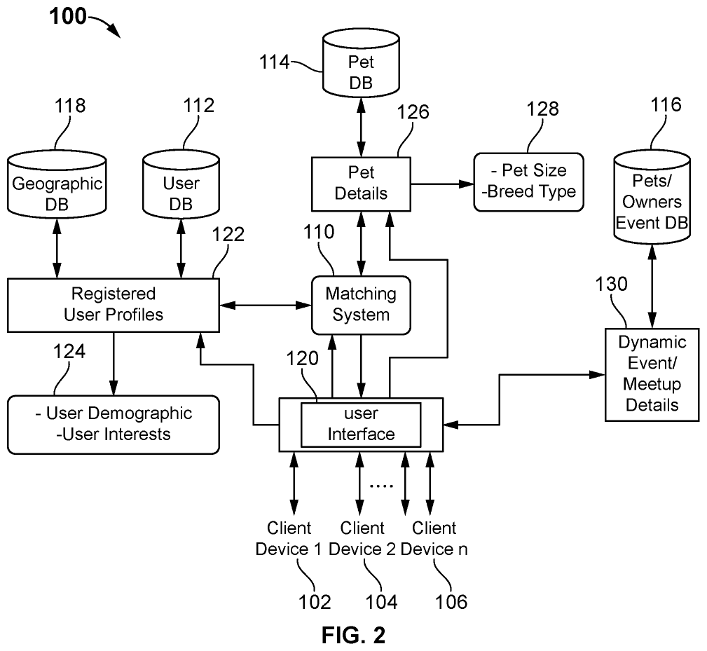

Referring to FIG. 2, a plurality of relevant databases in communication with each other for providing online dating service between the pet owners, according to one embodiment of the present invention. In one embodiment, the computer-implemented network environment 100 further comprises a plurality of user devices (102, 104, and 106) a matching server 110. The plurality of user devices (102, 104, and 106) are in communication with the matching server 110 via a user interface 120. In one embodiment, the system allows the user to interact with the other users via the user interface (i.e., Offleash'd interface) 120 configured to facilitate online dating service. In one embodiment, the user creates/generates a registered user profile 122 by registering user details into the system. The user creates the registered user profile 122 by entering one or more user information or user credentials via the user interface 120. In one embodiment, the registered user profile 122 is provided with one or more user demographics and user interests 124. These user details are stored in the user database 112 and graphic database 118.

In one embodiment, the user enters one or more pet details 126. In one embodiment, the user enters other pet attributes include, but are not limited to, pet size and breed type 128. The pet details 126 and the other attributes are stored in the pet database 114. In one embodiment, the registered user profiles get dynamically updated with pets/pet owners events 130 such as meet-ups, pet businesses, clinical sessions, etc. via the user interface 120. The dynamic event and/or meetup details are stored in the pet's/owner's event database 116. In one embodiment, the system provides dynamic recommendations of matching user profiles based on the user profiles, owner's interests, location, and the like. In one embodiment, the system allows the appropriate pet owners and their pets to dynamically update and/or arrange events such as meet-ups, pet businesses, clinical sessions, and pet-friendly dine with the other pet-owners and their pets.

In one embodiment, the matching server 110 executes a matching algorithm to extracts, stores and retrieves data from the databases such as user database 112, pet database 114, events databases 116, and geographic databases 118. In one embodiment, the matching server 110 stores and retrieves the plurality of user profiles from the appropriate database, and provide a response back to the appropriate user with their matching profiles. In one embodiment, the matching server 110 adaptively places relevant matching user/pet lover's profiles on the basis of various attributes such as user's interests, demographics, pet attributes such as pet type, pet size, pet birthday, pet's personality traits, pet name, pet age, pet type, and breed.

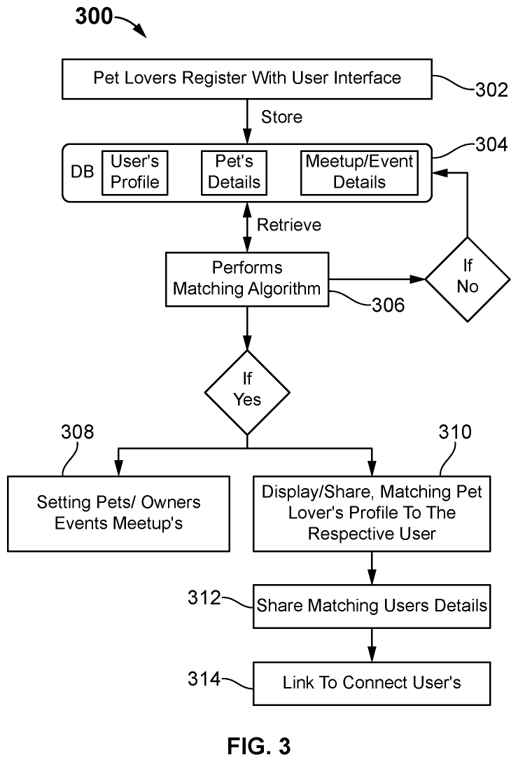

Referring to FIG. 3, a flowchart illustrating a method 300 of online dating service, according to one embodiment of the present invention. The method 300 includes the following steps. At step 302, a user registers into the system with a client interface i.e., Offleash'd interface to facilitate an online dating service between multiple pet lovers/clients. At step 304, the registered user/client profiles get stored in appropriate databases. In one embodiment, the user details and attributes are registered in a user database 112. In one embodiment, the attributes related to pets such as pet breeds, pet types, etc. are registered in a pet database 114. In one embodiment, the details relating to meet-ups, event details such as meet-ups for pet owners or pets, pet businesses etc. get registered in a events database 116. In one embodiment, the details relating to the location of the pet user are stored in a geographic database 118 which enables the users to filter their matching profiles within or nearer their geographic location.

At step 306, the system executes the matching server 110 comprising a matching algorithm using the retrieved data from the appropriate databases. In one embodiment, the algorithm checks for matching user profiles for the current user/client and generates matching profiles to the current user/client. In one embodiment, the user profile is determined based on the user preference. If a match/similar profile is not determined, the system moves to the previous step 304 and checks for other matching profiles among multiple user profiles. If a match/similar profile is determined, the system the next steps 308 and 310. At step 308, the system generates or sets pets or owners events, meet-ups etc. At step 310, the system displays or shares the matching pet owner's profile to the current user/client. At step 312, the system includes an option to share the matching user details to the current user/client. At step 314, the system includes an option to link to connect the current user/client to the appropriate user.

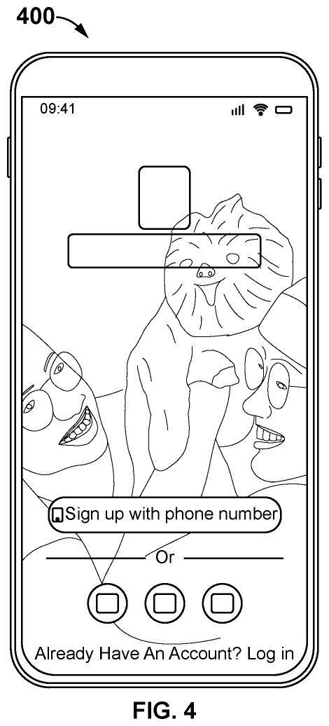

Referring to FIG. 4, a screenshot 400 showing a homepage of the system for pet owners, according to one embodiment of the present invention. In one embodiment, the system is an application or application software or mobile application or, web-based application. In one embodiment, the application shows a registration interface for registering user details to generate/create a registered user profile. In one embodiment, the user may register into the application using other social media networks or other applications, for example, Facebook®. In one embodiment, the user may enter into the application using other credentials such as phone number or email ID.

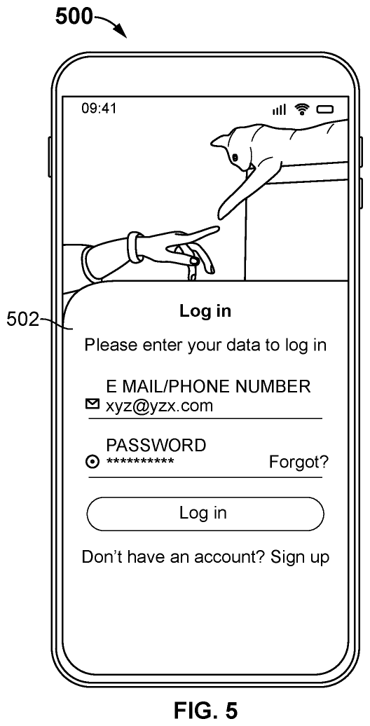

Referring to FIG. 5, a screenshot 500 illustrating the creation/generation of a user profile for the pet owner, according to one embodiment of the present invention. Upon successful registration, the system allows the user to create the user profile. In one embodiment, the user profile page collects the one or more user information such as first name and other details for creating the user profile. Upon creation of the user profile, the user interface allows the user to enter into the system. The user enters into the application using user login credentials 502 such as user name and password. The user's name may be email-id or phone number. In one embodiment, the created user profile is stored in the appropriate database to perform a profile matching with other stored profiles. In one embodiment, the user profile and the user information are stored in the user database 112.

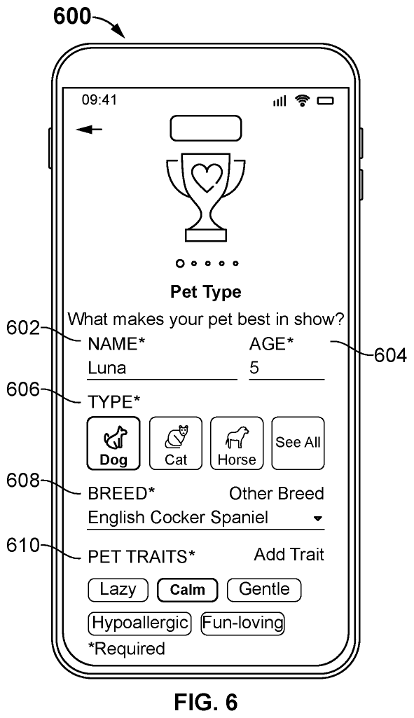

Referring to FIG. 6, a screenshot 600 to collect one or more details of the pets, according to one embodiment of the present invention. In one embodiment, the application collects the pet details such as pet birthday, breed, and personality traits, which help to find match. The details include, but not limited to, pet name 602, age 604, type 606, breed 608, and personality traits 610. In one embodiment, the user selects the type of pet and fills the corresponding name in the application. In one embodiment, the type 606 of the pet is selected from a given list. The pet type 606 may be a dog, cat, bird, horse, reptiles, fish, rabbit, amphibian, and others. The pet's breed of 608 may be selected from a drop-down list. The personality traits 610 may be selected from the given options. The personality traits 610 include, but not limited to, lazy, calm, hypoallergenic, and fun-loving.

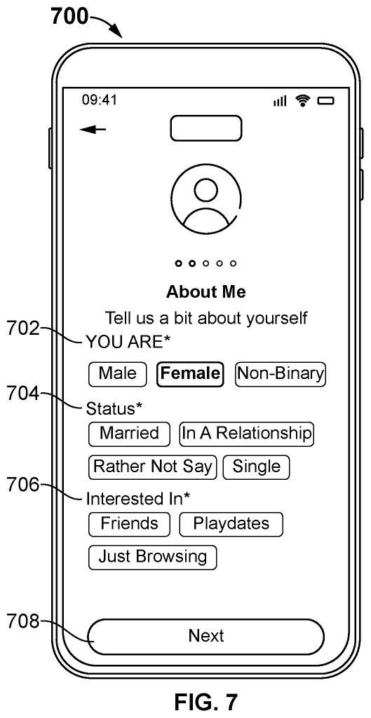

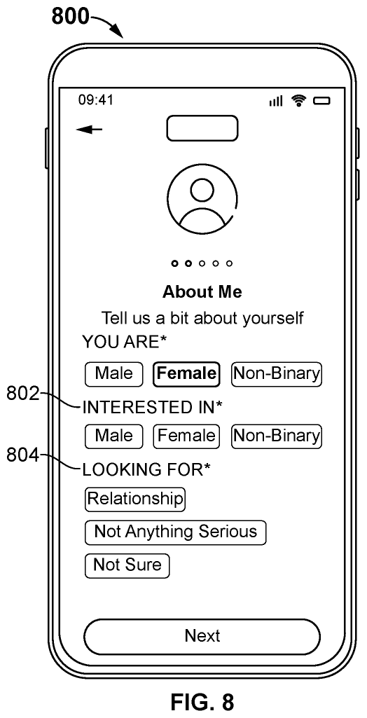

Referring to FIGS. 7-8, screenshots (700 and 800) to collect one or more details of the pet owner or user, according to one embodiment of the present invention. In one embodiment, the screenshots (700 and 800) comprise one or more options configured to select the user and the interested matching profiles based on their preference. The screenshot 700 comprises one or more options such as gender detail or “YOU ARE” 702, Status 704, and Interested in 706. The option gender detail or “YOU ARE” 702 of the pet owners may include male, female, or non-binary. The option “Status” 704 may include married, in a relationship, rather not say, or single. The option “interested in” 706 may include friends, playdates, and just browsing. The screenshot 700 further has “Next” option 708 to proceed further. The screenshot 800 comprises one or more options such as “interested in” 802 and “looking for” 804. The “interested in” option 802 includes male, female, or non-binary. The user selects any of the above genders for online dating. The “looking for” option 804 includes relationship, not anything serious, and not sure.

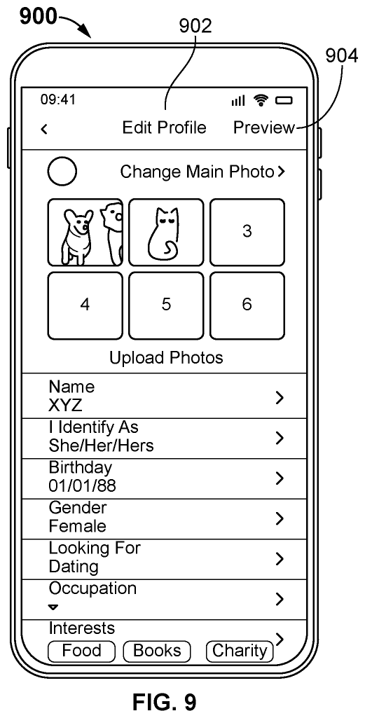

Referring to FIG. 9, a screenshot 900 to edit the details provided in the user profile, according to one embodiment of the present invention. The screenshot 900 comprises one or more options edit profile 902 and preview 904. The application allows the user to edit the user details such as profile photo, name, gender identification, birthday, looking for, occupation, interests, and about us using edit profile 902. The user can preview the user information provided on the user profile. The user can also upload the photos/images of their pets.

Further, the application allows the user to communicate with any of the other user. The user may create a group or join a group having a plurality of pet lovers. The system uses a predictive artificial intelligent (AI) technology. The predictive AI technology categorizes the user information and pet information to create different layers, which helps to find the match for friends, relationships, event to attend, and pet products to purchase and the type of animal to adopt during the date.

Advantageously, the system of the present invention is specially designed for pet lovers. The system provides an effective online dating service based on the user preference. The system provides an interactive communication tool to schedule or arrange pet events or owner's meet-ups based on matched user profiles. Further, the application includes artificial intelligence and matching algorithm to accomplish dating services through pets.

Preferred embodiments of this invention are described herein, including the best mode known to the inventors for carrying out the invention. It should be understood that the illustrated embodiments are exemplary only and should not be taken as limiting the scope of the invention.

The foregoing description comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings in the foregoing descriptions. Although specific terms may be employed herein, they are used only in generic and descriptive sense and not for purposes of limitation. Accordingly, the present invention is not limited to the specific embodiments illustrated herein.

What is claimed is:

1. A computer-implemented system to facilitate online dating service for associated pet owners, wherein the computer-implemented system allows the appropriate pet owners and their pets to dynamically update and/or arrange events such as meet-ups, pet businesses, clinical sessions, and pet-friendly dine with the other pet-owners and their pets, comprising:
a computing device having a processor and a memory in communication with the processor, wherein the memory stores a set of instructions executable by the processor;
a user device in communication with the computing device via a network, having a user interface with a user profile associated with each user configured to send the user information and receive plurality of other pet owner's information;
a plurality of databases configured to store a plurality of user information, pet information, event information, and geographic information, wherein the plurality of databases are user database, pet database, event database, and geographic database,
wherein the user profile is determined by matching a plurality of pet owner's profile based on pet profiles, pet attributes, pet birthday, pet's personality traits, pet name, pet age, pet type, and breeds stored in the database;
wherein the user profile is determined by matching a plurality of pet owner's profile with provision for viewing, sharing, and connecting with matched user profiles based on weighting factors and scores stored in the database, and
wherein the user profile is determined by matching a plurality of pet owner's profile with provision for retrieving matched pet owner detail based on geographical location stored in the database
wherein the computing device is in communication with the user device and the plurality of databases via a network configured to process the information received from the suitable databases and provide response back to the user device, thereby connecting the user profile with the plurality of other user profiles or pet owner profiles to view, connect or collaborate or arrange pet events or pet owners meet-ups,
wherein the computing device executes a set of instructions configured to:
check the matching user profiles for the current user/client;
display or share the matching pet owners profile to the current user/client, and
link or connect the current user/client by sharing the matching users' details to said pet events or pet owners meet-ups.

2. The system of claim 1, wherein the user device is configured to communicate with the computing device via the network using an application software or mobile application or, web-based application executed in a computer-implemented environment or network environment.

3. The system of claim 1, wherein the computing device is a matching server or online dating server.

4. The system of claim 1, wherein the user profile is generated by registering one or more user credentials into the system via the user interface.

5. The system of claim 1, wherein the computing device displays or shares matched pet owner profiles to the current user/client, thereby allowing the current user/client to filter the plurality of other pet owners profile based on their preference.

6. The system of claim 1, allows the current user/client to select the matching user profiles based on the user preference.

7. The system of claim 1, provides dynamic recommendations of matching user profiles based on the user profiles, owner's interests, and location.

8. The system of claim 1, wherein the user device is at least any one of a mobile phone, smartphone, tablet, laptop, computer, desktop, or other electronic communication devices.

9. A method for facilitating online dating service for associated pet owners using a computer-implemented system having a computing device that includes a processor and a memory in communication with the processor, wherein the memory stores a set of instructions executable by the processor; a plurality of databases including a user database, a pet database, an event database, and a geographic database, in communication with the computing device via a network configured to store a plurality of user information, pet information, event information, and geographic information, and a user device associated with a user in communication with the computing device via a network configured to send and receive plurality of other pet owner's information, wherein the method allows the appropriate pet owners and their pets to dynamically update and/or arrange events such as meet-ups, pet businesses, clinical sessions, and pet-friendly dine with the other pet-owners and their pets, comprising:
generating a user profile in the user device via the user interface, wherein the user information and the pet information are stored in an appropriate database;
performing matching algorithm using the computing device for connecting the current user/client profile with the plurality of other user profiles or pet owner profiles to view, connect or collaborate or arrange pet events or pet owners meet-ups;
displaying or sharing or attaching similar pet owners profile to the appropriate user for filtering based on the user preference;
generating or setting pets or owners events, meet-ups based on the matched user profile;
linking or connecting the selected user profile for setting meet-ups or other events;
wherein the user profile is determined by matching plurality of pet owners' profile based on pet profiles, pet attributes, pet birthday, pet's personality traits, pet name, pet age, pet type, and breeds stored in the database;
wherein the user profile is determined by matching plurality of pet owners' profile with provision for viewing, sharing, and connecting with matched user profiles based on weighting factors and scores stored in the database; and
wherein the user profile is determined by matching plurality of pet owners' profile with provision for retrieving matched pet owner detail based on geographical location stored in the database.

10. The method of claim 9, wherein the user device is configured to communicate with the computing device via the network using an application software or mobile application or, web-based application executed in a computer-implemented environment or network environment.

11. The method of claim 9, wherein the computing device is a matching server or online dating server.

12. The method of claim 9, wherein the user profile is generated by registering one or more user information and pet information into the system via the user interface.

13. The method of claim 9, allows the current user/client to select the matching profile based on the user preference.

14. The method of claim 9, provides dynamic recommendations of matching user profiles based on the user profiles, owner's interests, and location.
